(19) United States
(12) Patent Application Publication
(10) Pub. No.: US 2007/0133552 A1
(43) Pub. Date: Jun. 14, 2007

(54) Packet-relay unit

(76) Inventors: Seiji Kubo, Fukuoka (JP); Mikio Shimazu, Fukuoka (JP); Makoto Matuoka, Fukuoka (JP); Michinori Kishimoto, Fukuoka (JP); Yuji Shimizu, Fukuoka (JP)

Correspondence Address: WENDEROTH, LIND & PONACK L.L.P., 2033 K. STREET, NW, SUITE 800, WASHINGTON, DC, 20006, US

(21) Appl. No.: 10/588,110

(22) PCT Filed: Mar. 28, 2005
(86) PCT No.: PCT/JP05/06687

§ 371 Date: Jul. 31, 2006

(30) Foreign Application Priority Data
Apr. 1, 2004 (JP) 2004-108830

(51) Int. Cl. H04L 12/56; H04L 12/26

(52) U.S. Cl. 370/395.2; 370/235

(57) ABSTRACT

A packet-relay unit 100 including a first interface unit (110), a second interface unit (120), and a function-setting switch (130). The second interface unit (120) includes a classifying unit (121), a priority control unit (122), and a transceiving unit (123). When the function-setting switch (130) sets a “QoS function” as “operative”, the classifying unit (121) transfers packets transferred from the first interface unit (110) to the priority control unit (122). The priority control unit (122) provides priority control over the transferred packets such that the transferred packets are preferentially treated at a wireless zone connected to the second interface unit (120), whereby the priority-controlled packets are transferred to a transceiving unit (123) from the priority control unit (122). When the function-setting switch (130) sets “the QoS function” as “inoperative”, the classifying unit (121) transfers the transferred packets directly to the transceiving unit (123).

### TECHNICAL FIELD

The present invention relates to a relay unit operable to connect communication equipment to a network through two different transmission mediums.

### BACKGROUND ART

With network broadbandization, an art operable to control a QoS (Quality of Service) becomes increasingly more important to guarantee the quality of stream data such as moving images and audio on networks, and it is of significant importance to provide circumstances and equipment designed for the easy setting of a quality guarantee for ordinary users who are unfamiliar with the quality guarantee.

According to cited reference No. 1 (published Japanese Patent Application Laid-Open No. 2002-271360), there is disclosed a router unit having a physical priority switch disposed at a position from which the appearance of the priority switch is viewable. To realize a priority control function, i.e., one of QoS functions, the priority switch is operable to route one of Ethernet ports in preference to the other Ethernet ports.

FIG. 13 is a plan view illustrating a prior art packet-relay unit corresponding to the router unit as disclosed in cited reference No. 1. The packet-relay unit 1 as shown in FIG. 13 includes a switch 2, and Ethernet port switches “3a”, “3b”, “3c”, and “3d”. The switch 2 is operable to switch over between a WAN connection and a WAN disconnection. The Ethernet port switches “3a”, “3b”, “3c”, and “3d” are operable to switch connection of terminals, or rather personal computers PC1, PC2, PC3, and PC4, to a LAN. More specifically, each of the Ethernet port switches “3a”, “3b”, “3c”, and “3d” is operable to switch over the terminal-to-LAN connection among a preferential connection, a standard connection, and a disconnection. The above structure allows flows entering a particular Ethernet port to be treated in preference to the other flows that enter the other Ethernet ports.

Meanwhile, recent wireless LAN circumstances prevails rapidly because wireless packet transmission circumstances have been prevalent through the standardization of “IEEE802.11a” having the maximum transmission rate 54 Mbps and “IEEE802.11b” having the maximum transmission rate 11 Mbps, and because the wireless LAN is originally characterized in that there is no need to provide new wiring for packet transmission. At present, a new wireless LAN standard “IEEE802.11e” is under discussion.

According to cited reference No. 2, the “IEEE802.11e” or a wireless LAN standard in discussion is taught. For cited reference No. 2, refer to “Wireless LAN Standard IEEE802.11e for Realizing QoS”, written by OHTANI masahiro, URANO naoki, and UEDA tohru; Journal of The Institute of Image Information and Television Engineers, vol. 57, no. 11, pp. 1459-1464, 2003.

When packets transmitted through an Ethernet® (are radio-transmitted to the network through the relaying of the packets, the relayed packets are radio-transmitted at a speed smaller than that at which the pre-relayed packets are transmitted through Ethernet®. The relaying of the packets is likely to bring about a packet loss or a delay in packet transmission. In LAN circumstances employing transmission mediums other than the Ethernet®, the transmission speed is often varied, when compared with LAN circumstances employing only the Ethernet®, with a consequentially increased likelihood of the packet loss or the delay in packet transmission. Accordingly, what is important in LAN circumstances designed to communicate the packets through different transmission mediums is to exercise a priority control function for particular packets to a high degree enough to avoid a loss of the particular packets or a delay in transmission of the particular packets in order to provide guaranteed communication quality. In this instance, it is of significant importance to provide circumstances and equipment designed for the easy setting of a quality guarantee for ordinary users.

The prior art packet-relay unit of FIG. 13 is allowed to perform the priority control function only when all terminals are connected thereto through the Ethernet®, and is unresponsive to wireless LAN circumstances.

Meanwhile, there are problems as listed blow with access points (APs) available in the wireless LAN circumistances and PLC-Bridges available in balanced transmission channel circumstances for use in power line communication.

(a) The prior art packet-relay unit connected to all terminals through the Ethernet ® has a queue for each port, and is possible to receive all packets sent frond a plurality of terminals. In contrast, neither the wireless LAN access points (APs) nor the PLC-Bridges include ports, and they are impossible to simultaneously receive the packets from the plurality of terminals

(b) The prior art packet-relay unit includes a port for each of the terminals connected thereto, and sets a priority control function to each particular port. As a result, the packet-relay unit can readily provide priority control over packets received thereby from a terminal connected to each of those particular ports. However, neither the wireless LAN access points (APs) nor the PLC-Bridges include the ports, and it is difficult to identify each of the received packets by a corresponding one of the terminals.

Thus, it is extremely difficult that the wireless LAN access points (APs) and the PLC-Bridges are expected to offer advantages similar to those provided by the prior art packet-relay unit connecting a hardwired medium to a hardwired medium, even with an attempt to provide the priority control at the wireless LAN access points (APs) and the PLC-Bridges.

To overcome the problems as discussed at the above paragraphs (a) and (b) to provide the priority control, a packet-relay unit must be devised, whereby packets having the priority control function already imparted thereto are received by the wireless LAN access points (APs) and PLC-Bridges. The packets received by the wireless LAN access points (APs) and PLC-Bridges and having the priority control function already added thereto axe preferentially treated in the wireless LAN circumstances and the balanced transmission channel circumstances for use in power line communication, thereby providing guaranteed communication quality.

Such a new packet-relay unit must allow for the easy setting of the QoS for ordinary users who are unfamiliar with the quality guarantee.

In view of the above, an object of the present invention is to provide a packet-relay unit operable to connect communication equipment to a network through two different transmission mediums, and to set the quality guarantee to the transmitted packets.

### DISCLOSURE OF THE INVENTION

A first aspect of the present invention provides a packet-relay unit including: a first network interface unit connected to first communication equipment through a first transmission medium; a second network interface unit connected to second communication equipment through a second transmission medium; and a function-setting switch operable to set a quality guarantee to packets fed into the first network interface unit from the first communication equipment. The second network interface unit includes: a classifying unit operable to classify the packets in accordance with settings of the function-setting switch; a priority control unit operable to provide priority control over the packets such that the packets outputted from the second network interface unit are preferentially treated at a communication zone between the second network interface unit and the second communication equipment; and a transceiving unit operable to perform packet transmitting and receiving through the second transmission medium. In the packet-relay unit, when the function-setting switch is set to render the quality guarantee operative, the classifying unit transfers the packets from the first network interface unit to the priority control unit, the priority control unit provides the priority control over the packets transferred from the classifying unit, whereby the packets subjected to the priority control are transferred to the transceiving unit from the priority control unit. In the packet-relay unit, when the function-setting switch is set to render the quality guarantee inoperative, the classifying unit transfers the packets from the first network interface unit to the transceiving unit.

The above structure allows for the easy setting of the priority control function by operating the function-setting switch, whereby the packets sent from the packet-relay unit are treated in preference to those from other terminals at the communication zone connected to the second network interface unit. Accordingly, only switchover of the function-setting switch provides the easy and convenient setting of an appropriate priority control function, even with users who are innocent of QoS-related, detailed knowledge.

A second aspect of the present invention provides a packet-relay unit in which the first transmission medium differs from the second transmission medium.

A third aspect of the present invention provides a packet-relay unit in which the first transmission medium is a hardwired medium, but the second transmission medium is a wireless medium.

A fourth aspect of the present invention provides a packet-relay unit in which the first transmission medium is a hardwired medium, but the second transmission medium is a balanced transmission channel for use in power line communication.

As a result of the above structures, packets having the priority control function imparted thereto by the function-setting switch among the packets outputted from the packet-relay unit are treated in preference to packets from other terminals, even when the second transmission medium is, e.g., congested with traffic. In particular, the above advantage offered by the packet-relay unit according to the present invention is markedly exercised when the second transmission medium is either a wireless medium or a balanced transmission channel for use in power line communication, and the packets having the priority control function imparted thereto lead to a reduced loss of transmitted packets or a reduced delay in packet transmission.

A fifth aspect of the present invention provides a packet-relay unit in which the function-setting switch performs three-staged settings of the quality guarantee to the packets from the first network interface unit. In the packet-relay unit, when the function-setting switch performs a first-staged setting of the quality guarantee, the classifying unit transfers the packets from the first network interface to the priority control unit, and the priority control unit provides the priority control over the packets transferred from the classifying unit, whereby the packets subjected to the priority control are transferred to the transceiving unit from the priority control unit. In the packet-relay unit, when the function-setting switch performs a second-staged setting of the quality guarantee, the classifying unit transfers, to the priority control unit, a packet that satisfies a predetermined classifying condition among the packets from the first network interface unit, but transfers remnants of the packets from the first network interface unit to the transceiving unit, and the priority control unit provides the priority control over the packet that is transferred from the classifying unit and that satisfies the predetermined classifying condition, whereby the packet subjected to the priority control is transferred to the transceiving unit from the priority control unit. In the packet-relay unit, when the function-setting switch performs a third-staged setting of the quality guarantee, the classifying unit transfers the packets from the first network interface unit to the transceiving unit.

The above structure allows the function-setting switch to provide three-staged switchover to impart the priority control function to the packets. More specifically, a selection can be made as to whether the priority control function is imparted to all of the packets fed into the packet-relay unit, or otherwise as to whether the priority control function is imparted only to particular packets. As a result, users can selectively set whether the priority control function is imparted to the packets fed into the packet-relay unit, depending upon types of the aforesaid packets.

The sixth aspect of the present invention provides a packet-relay unit further including a priority control-setting switch. In the packet-relay unit, the priority control unit provides a different type of priority control over the packets from the first network interface unit in accordance with each setting of the priority control-setting switch.

The seventh aspect of the present invention provides a packet-relay unit in which the priority control-setting switch is set to allow the priority control unit to perform at least one of back-off setting, encoding rate setting, communication mode selection, and acknowledgement signal selection, by way of the priority control to be provided by the priority control unit over the packets from the first network interface unit.

The above structures allow the content of the priority control to be further specifically set for packets determined as targets to which the priority control function is to be imparted. To perform the back-off setting by way of the priority control, a back-off time shorter than a predetermined back-off time makes it feasible to transmit the packets on a priority basis.

To perform the encoding rate setting by way of the priority control, the packets are encoded by an encoding rate for use at a band Wider than a predetermined band, with a consequential decrease in packet receiving error.

To perform the communication mode selection by way of the priority control, a communication mode for use at a transmission band not heavily occupied by other terminals is selected, and efficient packet transmission is achievable.

To perform the acknowledgment signal selection by way of the priority control, usual “ACK” and “Block ACK” are selectable.

The above structures make it feasible to guarantee communication quality within finer limits.

The eighth aspect of the present invention provides a packet-relay unit in which the function-setting switch is a physical switch disposed at a position where the appearance of the function-setting switch is viewable.

The ninth aspect of the present invention provides a packet-relay unit in which the priority control-setting switch is a physical switch disposed at a position where the appearance of the priority control-setting switch is viewable.

The above structures provide an easily and conveniently user-settable selection of both of the priority control function and the priority control.

The tenth aspect of the present invention provides a packet-relay unit including: a first network interface unit connected to first communication equipment through a first transmission medium; a second network interface unit connected to second communication equipment through a second transmission medium; a first switch operable to set a quality guarantee to packets fed into the first network interface unit from the first communication equipment; and a marking unit operable to set priority to the packets from the first network interface unit in accordance with settings of the first switch, whereby the packets having the priority set thereto are transferred to the second network interface unit from the marking unit. In the packet-relay unit, when the first switch is set to render the quality guarantee operative, the marking unit sets higher priority to the packets from the first network interface unit. In the packet-relay unit, when the first switch is set to render the quality guarantee inoperative, the marking unit sets lower priority to the packets from the first network interface unit.

The above structure allows the marking unit to entirely or partially overwrite the packets from the first network interface unit when the first switch is set to render the quality guarantee operative, whereby higher priority is set to the overwritten packets. To set the higher priority, a value of a DSCP (Differentiated Services Code Point) in each of the packets may be overwritten. As a result, the packets having the higher priority set thereto and outputted from the packet-relay unit are treated as targets to be priority-controlled in the network connected to the packet-relay unit, whereby assured communication quality is achievable. To render the quality guarantee either operative or inoperative, users can conveniently operate the first switch with ease.

The eleventh aspect of the present invention provides a packet-relay unit in which the second network interface unit includes: a classifying unit operable to classify the packets in accordance with the priority set by the marking unit; a priority control unit operable to provide priority control over the packets such that the packets outputted from the second network interface unit are preferentially treated at a communication zone between the second network interface unit and the second communication equipment; and a transceiving unit operable to perform packet transmitting and receiving through the second transmission medium. In the packet-relay unit, when the first switch is set to render the quality guarantee operative, the marking unit sets higher priority to the packets from the first network interface unit, whereby the packets having the higher priority set thereto are transferred to the classifying unit from the marking unit. In the packet-relay unit, when the first switch is set to render the quality guarantee inoperative, the marking unit sets lower priority to the packets from the first network interface unit, whereby the packets having the lower priority set thereto are transferred to the classifying unit from the marking unit. The classifying unit transfers the packets having the higher priority set thereto to the priority control unit, but transfers remnants of the packets from the first network interface unit to the transceiving unit. The priority control unit provides the priority control over the packets that are transferred from the classifying unit and that have the higher priority set to the packets, whereby the packets subjected to the priority control are transferred to the transceiving unit from the priority control unit.

The above structure allows the second network interface unit to provide the priority control over the packets having higher priority set thereto by the marking unit, whereby the priority-controlled packets are transmitted to the external network from the packet-relay unit. The back-off setting, encoding rate setting, communication mode selection, and acknowledgment signal selection may be executed by way of the priority control.

The twelfth aspect of the present invention provides a packet-relay unit in which the first switch performs three-stage settings of the quality guarantee to the packets from the first network interface unit. In the packet-relay unit, when the first switch performs a first-staged setting of the quality guarantee, the marking unit sets higher priority to the packets from the first network interface unit, whereby the packets having the higher priority set thereto are transferred to the classifying unit from the marking unit. In the packet-relay unit, when the first switch performs a second-staged setting of the quality guarantee, the marking unit sets higher priority to a packet that satisfies a predetermined classifying condition among the packets from the first network interface unit, whereby the packet having the higher priority set thereto is transferred to the classifying unit from the marking unit, but the marking unit sets lower priority to remnants of the packets from the first network interface unit, whereby the remnants having the lower priority set thereto are transferred to the classifying unit from the marking unit. In the packet-relay unit, when the first switch performs a third-staged setting of the quality guarantee, the marking unit sets lower priority to the packets from the first network interface unit, whereby the packets having the lower priority set thereto are transferred to the classifying unit from the marking unit.

The above structure provides user-selectable three different choices as to whether packets to be transmitted are free of the quality guarantee, and as to that the aforesaid packets contain the quality guarantee, depending upon types of the packets. As a result, the communication quality can be guaranteed within fine limits for each of the types of the packets.

The thirteenth aspect of the present invention provides a packet-relay unit as defined in claim 12, further including a second switch operable to set the classifying condition for use in packet classification. In the packet-relay unit, when the first switch performs the second-staged setting of the quality guarantee, the marking unit classifies the packets from the first network interface unit in accordance with the classifying condition set by the second switch.

The fourteenth aspect of the present invention provides a packet-relay unit in which the second switch sets the classifying condition based on at least one of a DSCP (Differentiated Services Code Point), a TOS (Type of Service), a VLAN (Virtual Local Area Network) priority bit, a MAC (Media Access Control) address, an IP (Internet Protocol) address, a port number, a protocol number, and a flow label.

The above structures provide classifying condition-based, user-selectable types of packets to be quality-guaranteed, in which the classifying conditions are set by the second switch, and easy operation required to set the classifying conditions is achievable.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram illustrating a packet-relay unit according to a first embodiment of the present invention;

FIG. 2 is block diagram illustrating a packet-relay unit according to a third embodiment;

FIG. 3 is a block diagram illustrating a packet-relay unit according to a fourth embodiment;

FIG. 4 is block diagram illustrating a packet-relay unit according to a fifth embodiment;

FIG. 5 is a block diagram illustrating a packet-relay unit according to a seventh embodiment;

FIG. 6 is an illustration showing the appearance of the packet-relay unit according to the first embodiment;

FIG. 7 is an illustration showing the appearance of a switch according to the second embodiment;

FIG. 8 is an illustration showing the appearance of a priority control-setting switch according to the third embodiment;

FIG. 9 is an illustration showing the appearance of a second switch according the seventh embodiment;

FIG. 10 is an illustration showing exemplary packet-relay units according an eighth embodiment when applied to a wireless LAN;

FIG. 11 is a block diagram illustrating a packet-relay unit according to a ninth embodiment;

FIG. 12 is an illustration showing the exemplary packet-relay units according to the ninth embodiment when applied to a power line network; and

FIG. 13 is a plan view illustrating a prior art packet-relay unit.

### BEST MODE FOR CARRYING OUT THE INVENTION

Embodiments of the present invention are now described with reference to the accompanying drawings.

### FIRST EMBODIMENT

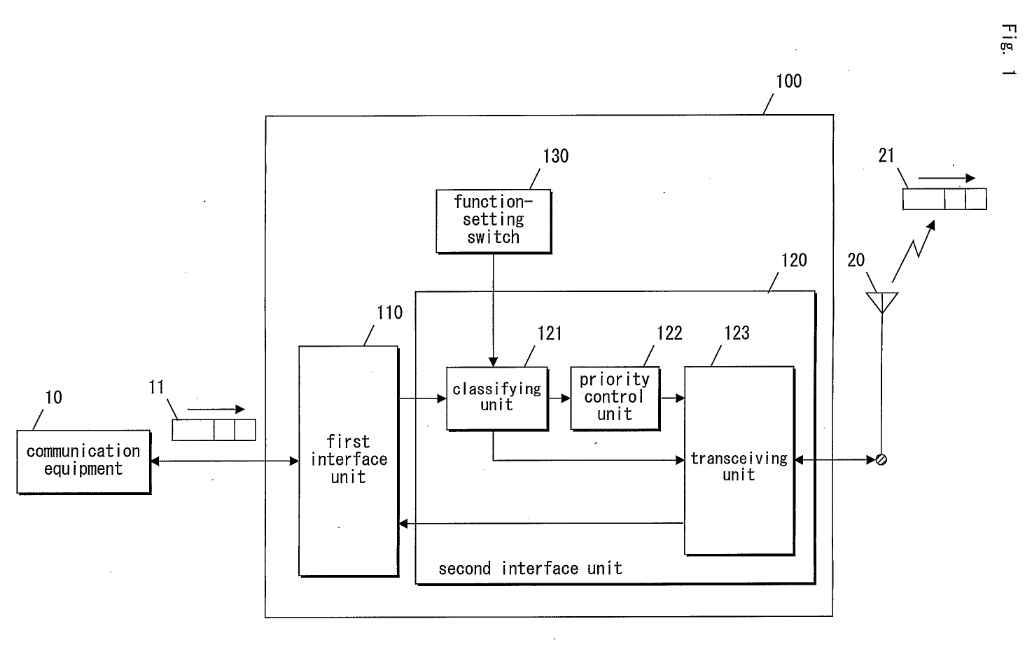

FIG. 1 is a block diagram illustrating a packet-relay unit 100 according to a first embodiment. The packet-relay unit 100 according to tile present embodiment includes a first interface unit 110, a second interface unit 120, and a function-setting switch 130. The second interface unit 120 includes a classifying unit 121, a priority control unit 122, and a transceiving unit 123. The function-setting switch 130 makes a selection, and results from the selection are transmitted from the function-setting switch 130 to the classifying unit 121.

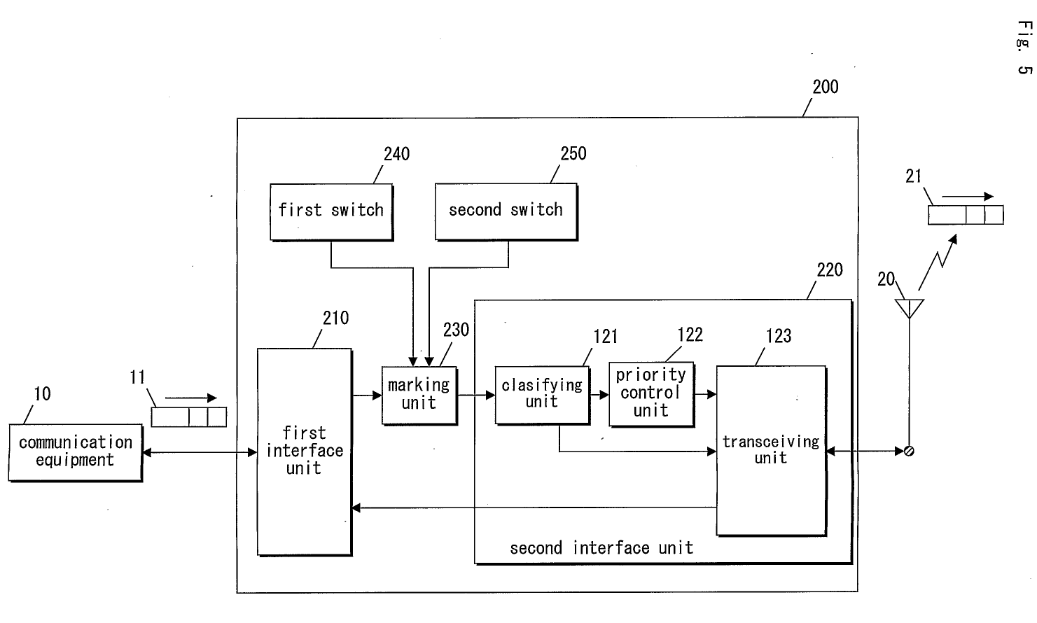

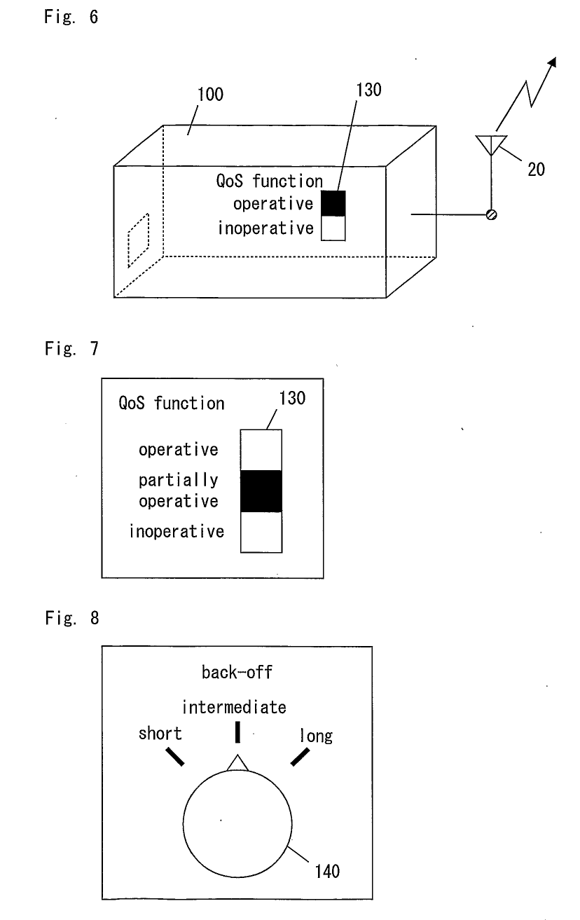

FIG. 6 is an illustration showing the appearance of the packet-relay unit 100 according to the present embodiment. As illustrated in FIG. 6, the packet-relay unit 100 according to the present embodiment is placed in a chassis. The function-setting switch 130 is mounted on the chassis on the surface thereof at a position where the function-setting switch 130 is over-viewable.

The following description assumes that the first interface unit 110 of FIG. 1 is connected to communication equipment 10 through a cable Ethernet®, and that the second interface unit 120 is connected to an access point on a network by radio through an antenna 20. More specifically, the packet-relay unit 100 according to the present embodiment is connected to the first cable transmission medium and the second radio transmission medium. The communication equipment 10 corresponds to first communication equipment such as a personal computer, a printer, an IP phone, and network-adapted household appliances (a camera, a TV, and a DVD). The access point (not shown) on the network corresponds to second communication equipment.

To be connected to the access point on the network by radio, the second interface unit 120 uses a protocol such as IEEE802.11a/b/g connectable to a LAN and WAN by radio.

The following discusses behaviors of the packet-relay unit 100 according to the present embodiment.

The first interface unit 110 is operable to transfer packets 11 to the second interface unit 120 at the classifying unit 121 upon receipt of the packets 11 from the communication equipment 10.

As illustrated in FIG. 6, when the function-setting switch 130 is set to the position “operative”, a QoS function is rendered operative, and the classifying unit 121 of FIG. 1 transfers the packets transferred from the first interface unit 110 to the priority control unit 122. The priority control unit 122 is operable to provide priority control over the transferred packets from the classifying unit 121 to allow the aforesaid packets to be preferentially treated at the wireless zone. The priority-controlled packets are transferred from the priority control unit 122 to the transceiving unit 123.

When the function-setting switch 130 of FIG. 6 is set to the position “inoperative”, then the QoS function is rendered inoperative, and the classifying unit 121 of FIG. 1 transfers the packets transferred from the first interface unit 110 directly to the transceiving unit 123.

The transceiving unit 123 is operable to transmit, in the form of packets 21, the transferred packets from the priority control unit 122 or those from the classifying unit 121 to the network by radio through the antenna 20.

When the second interface unit 120 receives packets from the network, then the transceiving unit 123 transfers the received packets to the first interface unit 110, and the first interface unit 110 transfers them to the communication equipment 10.

Pursuant to the present embodiment, as exemplary priority control executed by the priority control unit 122, there is available a method for reducing at least either one of a back-off time and a carrier sense time, both of which are used in CSMA/CA system wireless communication. The CSMA/CA system is short for Carrier Sense Multiple Access with Collision Avoidance, and is a wireless LAN protocol to be run on MAC layers.

The back-off and carrier sense time is a queuing time in the CSMA/CA system wireless communication. The queuing time lasts until the moment when the packet-relay unit 100 transmits the packets from the moment when it is ascertained that no radio waves are outputted from other terminals.

A shorter packet back-off time allows the packet-relay unit 100 to transmit the packets to the access point on the network after the lapse of a shorter queuing time, when compared with the way in which other terminals transmit packets, and packet transmission on a higher-priority basis is achievable.

As described above, the packet-relay unit 100 according to the Present embodiment allows for the easy setting of a quality guarantee, even with users innocent of knowledge on quality guarantee setting, by only switchover of the function-setting switch 130 mounted on the chassis of the packet-relay unit 100 on the surface thereof.

Furthermore, the use of the packet-relay unit 100 according to the present embodiment allows for the easy setting of the quality guarantee to packets having no priority control imparted thereto by the communication equipment 10.

### SECOND EMBODIMENT

A block diagram illustrating a packet-relay unit 100 according to a second embodiment is similar to that of FIG. 1 as described in the previous embodiment except for a function-setting switch 130. The function-setting switch 130 according to the present embodiment provides switchover among three different stages.

FIG. 7 is an illustration showing the appearance of the function-setting switch 130 according to the present embodiment. As illustrated in FIG. 7, the function-setting switch 130 is operable to set a QoS function among the three different stages of “operative”, “partially operative”, and “inoperative”. The following discusses behaviors according to the present embodiment.

When the function-setting switch 130 of FIG. 7 is set to the position “operative”, then the QoS function is rendered operative, and a classifying unit 121 of FIG. 1 transfers packets transferred from a first interface unit 110 to a priority control unit 122. The priority control unit 122 is operable to provide priority control cover the transferred packets from the classifying unit 121 to allow the aforesaid packets to be preferentially treated at the wireless zone. The priority-controlled packets are transferred from the priority control unit 122 to a transceiving unit 123.

When the function-setting switch 130 of FIG. 7 is set to the position “partially operative”, then the QoS function is rendered operative for certain packets, but inoperative for the other packets. The classifying unit 121 is operable to set a packet-classifying condition in advance. When the function-setting switch 130 is set as “partially operative”, the classifying unit 121 determines whether the packets transferred from the first interface unit 110 satisfy the packet-classifying condition. The classifying unit 121 selects particular packets that satisfy the packet-classifying condition, based on the determination, and transfers the selected packets to the priority control unit 122, but transfers the other packets to the transceiving unit 123. The priority control unit 122 provides the priority control over the particular packets transferred from the classifying unit 121 to allow the aforesaid packets to be preferentially treated at the wireless zone. The priority-controlled packets are transferred from the priority control unit 122 to the transceiving unit 123.

When the function-setting switch 130 of FIG. 7 is set to the position “inoperative”, then the QoS function is rendered inoperative, and the classifying unit 121 of FIG. 1 transfers the packets transferred from the first interface unit 110 directly to the transceiving unit 123.

The transceiving unit 123 is operable to transmit, in the form of packets 21, the packets transferred from the priority control unit 122 or those from the classifying unit 121 to the network by radio through an antenna 20.

The packet-classifying condition as discussed above may include either single one of elements as discussed below, or a combination of two or greater elements; a MAC address; an IP address; a DSCP; a TOS; a VLAN priority bit; a port number; a protocol number; and flow label. The elements are contained in each of the packets at the field of header information thereof.

For example, assume that the IP address is used as one of the packet-classifying conditions. In this assumption, the classifying unit 121 selects only packets having that particular IP address, and then transfers the selected packets to the priority control unit 122. The priority control unit 122 provides the priority control over the transferred packets, thereby transmitting the priority-controlled packets to the network on a higher-priority basis.

In the packet-relay unit according to the present embodiment, one of the packet-classifying conditions is set in the classifying unit 121 to allow the classifying unit 121 to select the packets. Alternatively, a plurality of the packet-classifying conditions may be set either in or on the classifying unit 121 to select one of the packet-classifying conditions using a separately available switch, thereby providing results from the selection. The classifying unit 121 is allowed to select the packets in accordance with the aforesaid selection results. In this alternative, a switch similar to a second switch 250 according to a seventh embodiment as discussed later may be connected to the classifying unit 121.

### THIRD EMBODIMENT

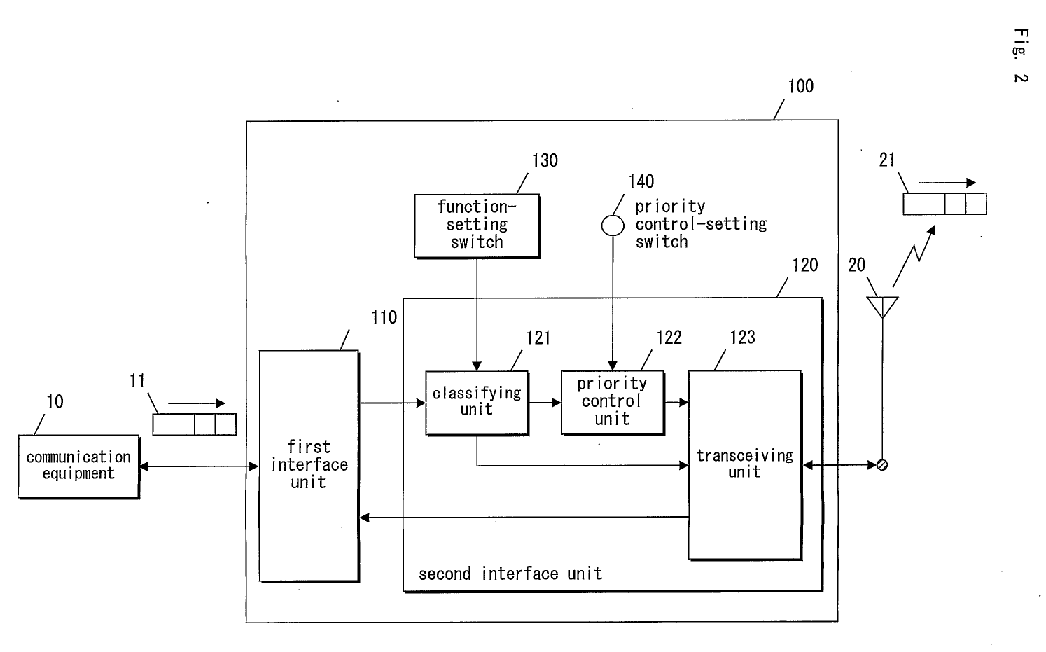

FIG. 2 is a block diagram illustrating a packet-relay unit 100 according to a third embodiment. In FIG. 2, elements similar to those of FIG. 1 are identified by the same reference characters, and descriptions thereon are herein omitted.

The packet-relay unit 100 according to the present embodiment includes a first interface unit 110, a second interface unit 120, a function-setting switch 130, and a priority control-setting switch 140. The second interface unit 120 includes a classifying unit 121, a priority control unit 122, and a transceiving unit 123. The function-setting switch 130 makes a selection, and transmits results from the selection to the classifying unit 121. The priority control-setting switch 140 makes a selection, and transmits results from the selection to the priority control unit 122.

The packet-relay unit 100 according to the present embodiment differs from that according to the first embodiment because the priority control-setting switch 140 is added thereto, and consequently provides a corresponding new function.

The following discusses behaviors of the packet-relay unit 100 according to the present embodiment, focusing on the new function provided by the packet-relay unit 100 according to the present embodiment. Assume that the function-setting switch 130 renders a QoS function settable between “operative” and “inoperative” as illustrated in FIG. 6.

When the function-setting switch 130 is set as “operative”, then the classifying unit 121 transfers packets transferred from the first interface unit 110 to the priority control unit 122. When the function-setting switch 130 is set as “inoperative”, the classifying unit 121 transfers the transferred packets directly to the transceiving unit 123.

FIG. 8 is an illustration showing the appearance of the priority control-setting switch 140 according to the present embodiment. As illustrated in FIG. 8, the priority control-setting switch 140 according to the present embodiment is a rotary switch operable to set a back-off time to three different stages of “short”, “intermediate”, and “long”. Similarly to the function-setting switch 130 of FIG. 6, the priority control-setting switch 140 is also mounted on a chassis on the surface thereof in which the packet-relay unit 100 according to the present embodiment is contained.

When the priority control-setting switch 140 of FIG. 8 is set as “short”, the priority control unit 122 of FIG. 2 sets a shorter back-off time to packets transferred from the classifying unit 121, before transferring the aforesaid packets to the transceiving unit 123. As a result, the packets are transmitted from the transceiving unit 123 to the access point on the network after the lapse of a shorter queuing time, when compared with the way in which packets are transmitted from other terminals, and consequently packet transmission on a higher-priority basis is achievable.

When the priority control-setting switch 140 of FIG. 8 is set as “intermediate”, the priority control unit 122 of FIG. 2 sets an average back-off time to the packets transferred from the classifying unit 121, before transferring the aforesaid packets to the transceiving unit 123. As a result, the packets are transmitted from the transceiving unit 123 to the access point on the network after the lapse of a queuing time equal on average to that involved in the packet transmission from other terminals, and consequently the packets are transmitted on an intermediate priority basis.

When the priority control-setting switch 140 is set as “long”, the priority control unit 122 of FIG. 2 sets a longer back-off time to the packets transferred from the classifying unit 121, before transferring the aforesaid packets to the transceiving unit 123. As a result, the packets are transmitted from the transceiving unit 123 to the access point on the network after the lapse of a longer queuing time, when compared with the packet transmission from other terminals, and consequently the packets are transmitted on a lower priority basis.

As described above, the packet-relay unit 100 according to the present embodiment offers a combination of the function-setting switch 130 and the priority control-setting switch 140, whereby the packets are transmitted on the basis of priority settable within fine limits. In addition, the packet-relay unit 100 according to the present embodiment allows for the easy setting of the quality guarantee, even with users innocent of detailed knowledge on quality guarantee setting, by only changeover of the switch disposed on the chassis on the surface thereof.

Although the priority control-setting switch 140 as discussed above sets the different back-off times, the priority control-setting switch 140 is not limited thereto. Alternatively, the priority control-setting switch 140 may execute other types of priority control.

Assuming that the priority control-setting switch 140 sets an encoding rate as another type of priority control, the priority control unit 122 encodes the packets transferred from the classifying unit 121 in accordance with the encoding rate set by the priority control-setting switch 140. Several different encoding rates may be set to control the probability of the occurrence of packet receiving errors, and the communication quality of the packets is controllable.

As a further type of priority control, the priority control-setting switch 140 may be set to make a communication mode selection or otherwise an acknowledgement signal selection. The communication mode selection is a selection to be timely made from a heavier traffic communication band-based communication mode to a lighter traffic communication band-based communication mode. The acknowledgement signal selection is a selection of usual “ACK” and “Block ACK”.

### FOURTH EMBODIMENT

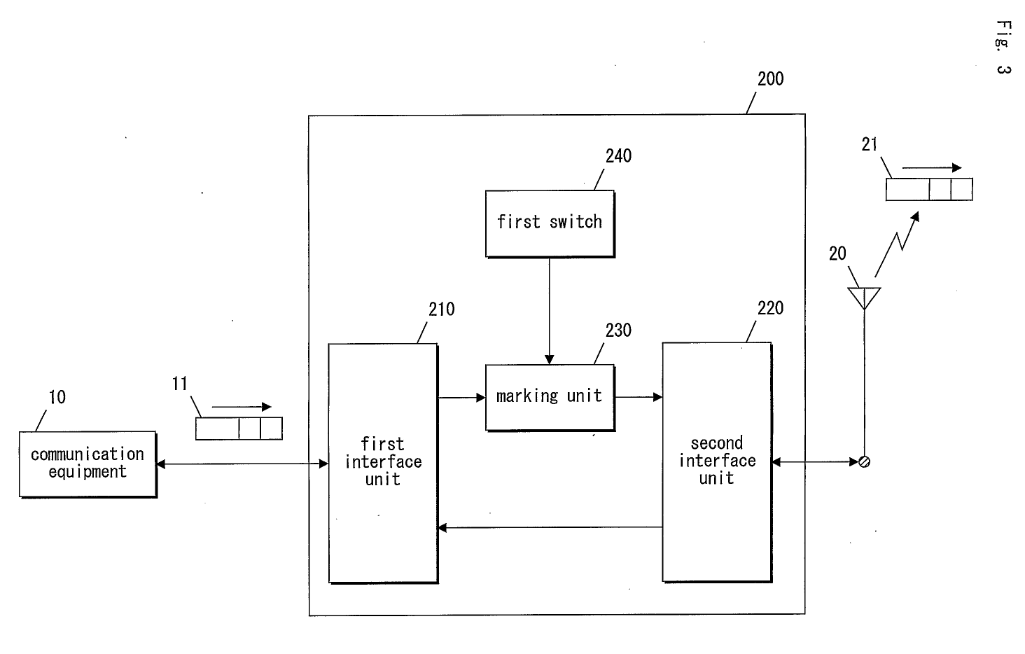

FIG. 3 is a block diagram illustrating a packet-relay unit 200 according to a fourth embodiment. The packet-relay unit 200 according to the present embodiment includes a first interface unit 210, a second interface unit 220, a marking unit 230, and a first switch 240.

Similarly to the first embodiment, the following description assumes that the first interface unit 210 is connected to communication equipment 10 through a cable Ethernet®, but the second interface unit 220 is connected to an access point on a network by radio through an antenna 20.

The first interface unit 210 is operable to transfer packets 11 to the marking unit 230 upon receipt of the packets 11 from the communication equipment 10.

The first switch 240 is operable to set whether a quality guarantee is rendered operative or inoperative for the packets fed into the first interface unit 210.

When the first switch 240 sets the quality guarantee as operative, the marking unit 230 sets higher priority to the packets transferred from the first interface unit 210, before transferring the aforesaid packets to the second interface unit 220.

When the first switch 240 sets the quality guarantee as inoperative, the marking unit 230 sets lower priority to the packets transferred from the first interface unit 210, before transferring the aforesaid packets to the second interface unit 220.

The second interface unit 220 is operable to transmit, in the form of packets 21, the packets transferred from the marking unit 230 to the network by radio through the antenna 20.

The marking unit 230 either partially or entirely overwrites the packets from the first interface unit 210, thereby setting priority to the overwritten packets. To set the priority to the packets, a value of a DSCP (Differentiated Services Code Point) in each of the packets may be overwritten. As a result, packets having higher priority set thereto are outputted from the packet-relay unit 200 to the network connected to the packet-relay unit 200 by radio, and are treated as priority control targets in the network, whereby assured communication quality is achievable.

### FIFTH EMBODIMENT

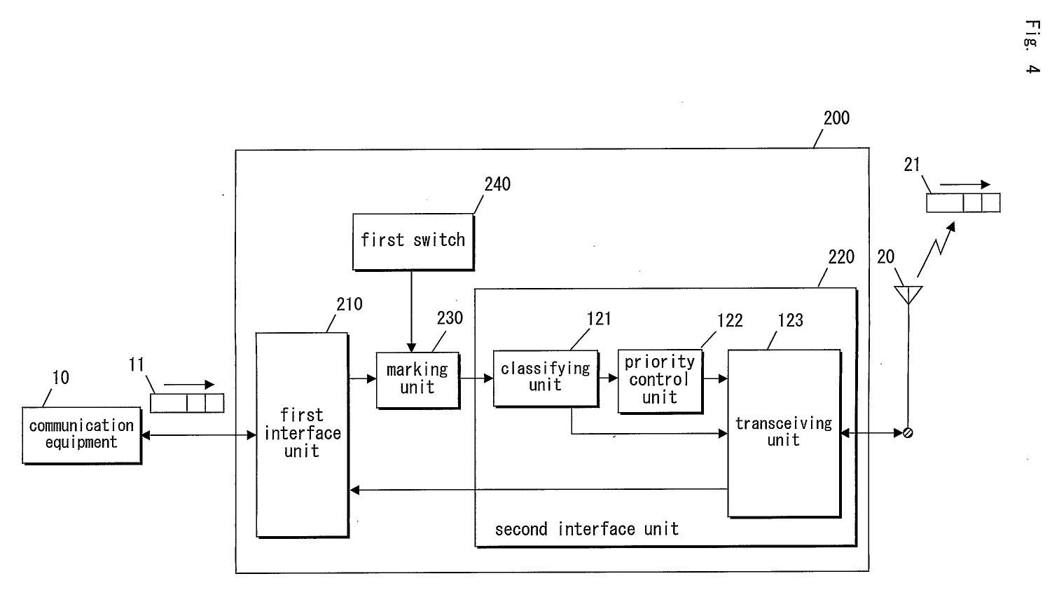

FIG. 4 is block diagram illustrating a packet-relay unit 200 according to a fifth embodiment. The packet-relay unit 200 according to the present embodiment includes a first interface unit 210, a second interface unit 220, a marking unit 230, and a first switch 240. The second interface unit 220 includes a classifying unit 121, a priority control unit 122, and a transceiving unit 123.

Similarly to the first embodiment, the following description assumes that the first interface unit 210 is connected to communication equipment 10 through a cable Ethernet®, but the second interface unit 220 is connected to an access point on a network by radio through an antenna 20.

Similarly to the fourth embodiment, the first switch 240 according to the present embodiment is operable to set whether a quality guarantee is rendered operative or inoperative.

When the first switch 240 sets the quality guarantee as operative, the marking unit 230 sets higher priority to packets transferred from the first interface unit 210, before transferring the aforesaid packets to the classifying unit 121.

When the first switch 240 sets the quality guarantee as inoperative, the marking unit 230 sets lower priority to the packets transferred from the first interface unit 210, before transferring the aforesaid packets to the classifying unit 121.

The classifying unit 121 is operable to transfer the packets transferred from the marking unit 230 to the priority control unit 122 when the transferred packets have the higher priority set thereto, but is operable to transfer the transferred packets directly to the transceiving unit 123 when they have the lower priority set thereto.

The priority control unit 122 is operable to execute priority control over the packets having the higher priority set thereto and transferred from the classifying unit 121. The priority-controlled packets are transferred from the priority control unit 122 to the transceiving unit 123.

The transceiving unit 123 is operable to transmit the transferred packets to the network by radio through the antenna 20.

Similarly to the third embodiment, the priority control unit 122 according to the present embodiment may perform, by way of the priority control, either one of back-off setting, encoding rate setting, communication mode selection, and acknowledgement signal selection.

### SIXTH EMBODIMENT

A block diagram illustrating a packet-relay unit 200 according to a sixth embodiment is similar to that of FIG. 4 as described in the fifth embodiment, except for a first switch 240 operable to provide changeover among three different stages.

More specifically, the first switch 240 is similar in appearance to the function-setting switch 130 according to the second embodiment as illustrated in FIG. 7, and is operable to set a QoS function among three different stages of “operative”, “partially operative”, and “inoperative”.

The following discusses behaviors according to the present embodiment.

When the first switch 240 is set to the position “operative”, the QoS function is rendered operative, and a marking unit 230 sets higher priority to packets transferred from a first interface unit 210, before transferring the aforesaid packets to a classifying unit 121.

When the first switch 240 is set to the position “partially operative”, the QoS function is rendered operative for only particular packets, but inoperative for the other packets. To this end, the marking unit 230 is operable to classify the packets transmitted from the first interface unit 210 in accordance with a predetermined classifying condition. As a result, higher priority is set to particular packets that satisfy the classifying condition, thereby transferring the packets having the higher priority set thereto to the classifying unit 121, but lower priority is set to packets that do not satisfy the predetermined classifying condition, and the packets having the lower priority set thereto are transferred to the classifying unit 121.

When the first switch 240 is set to the position “inoperative”, the QoS function is rendered inoperative, and the marking unit 230 sets lower priority to the packets transferred from the first interface unit 110, before transferring the aforesaid packets to the classifying unit 121.

The classifying unit 121 is operable to classify the packets transferred from the marking unit 230 in accordance with the priority set to the transferred packets. More specifically, the classifying unit 121 is operable to transfer the packets having the higher priority set thereto to a priority control unit 122, but to transfer the packets having the lower priority set thereto directly to a transceiving unit 123.

The priority control unit 122 is operable to provide priority control over the packets having the higher priority set thereto and transferred from the classifying unit 121, and the priority-controlled packets are transferred from the priority control unit 122 to the transceiving unit 123.

The transceiving unit 123 is operable to transmit the packets transferred from the priority control unit 122 and those directly transferred from the classifying unit 121 to the network by radio through the antenna 20.

In the packet-relay unit 200 according to the present embodiment, when the first switch 240 is set to the position “partially operative”, then the QoS function is rendered operative for only particular packets. The particular packets are selected by the marking unit 230 in accordance with the predetermined classifying condition.

The above classifying condition may include header information such as, e.g., a DSCP, a TOS, a VLAN priority bit, a MAC address, an IP address, a port number, a protocol number, and a flow label. For example, assume that the classifying condition includes the IP address, and in this connection the marking unit 230 sets higher priority to packets having that particular IP address, before transferring them to the classifying unit 121, but sets lower priority to packets having the other IP addresses, before transferring them thereto. Thus, only packets having that particular IP address are transferred by the classifying unit 121 to the priority control unit 122, and the priority control unit 122 provides the priority control over the aforesaid packets, thereby outputting the priority-controlled packets from the transceiving unit 123 to the network. As a result, the aforesaid packets having that particular IP address are treated on a priority basis in the network.

The priority control unit 122 may perform, by way of the priority control, either one of back-off setting, encoding rate setting, communication mode selection, and acknowledgement signal selection.

### SEVENTH EMBODIMENT

FIG. 5 is a block diagram illustrating a packet-relay unit 200 according to a seventh embodiment. The packet-relay unit 200 according to the present embodiment includes a first interface unit 210, a second interface unit 220, a marking unit 230, and a first switch 240, and a second switch 250. The second interface unit 220 includes a classifying unit 121, a priority control unit 122, and a transceiving unit 123.

Similarly to the sixth embodiment, the first switch 240 according to the present embodiment is operable to set a QoS function among three different stages of “operative”, “partially operative”, and “inoperative”.

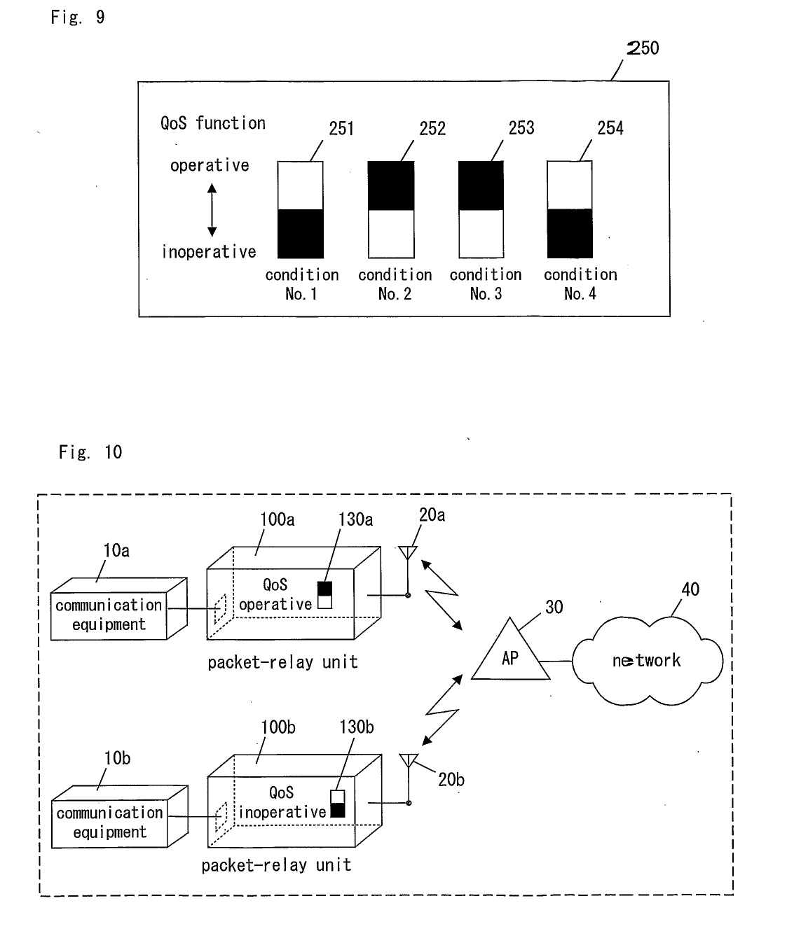

The second switch 250 is operable to set classifying conditions for use by the marking unit 230. FIG. 9 is an illustration showing the appearance of the second switch 250 according to the present embodiment.

As illustrated in FIG. 9, the second switch 250 according to the present embodiment is operable to set four different types of classifying conditions as the QoS function. A switch 251 is operable to set condition No. 1 between “operative” and inoperative”. A switch 252 is operable to set condition No. 2 between “operative” and “inoperative”. A switch 253 is operable to set condition No. 3 between “operative” and “inoperative”. A switch 254 is operable to set condition No. 4 between “operative” and “inoperative”. According to the example as illustrated in FIG. 9, the conditions Nos. 1, 2, 3, and 4 are set as “inoperative”, “operative”, “operative”, and “inoperative”, respectively.

The following outlines behaviors of the packet-relay unit 200 according to the present embodiment.

When the first switch 240 is set to the position “operative”, the QoS function is rendered operative, and the marking unit 230 sets higher priority to packets transferred from the first interface unit 210, before transferring the aforesaid packets to the classifying unit 121.

When the first switch 240 is set to the position “partly operative”, the QoS function is rendered operative for only particular packets that satisfy the classifying conditions set by the second switch 250, but is rendered inoperative for the other packets. Among the packets transferred from the first interface unit 210, the marking unit 230 sets higher priority to packets that meet classifying conditions consisting of conditions No. 2 and No. 3 as illustrated by the illustrated example of FIG. 9, and the packets having the higher priority set thereto are transferred to the classifying unit 121 from the marking unit 230. Meanwhile, the marking unit 230 sets lower priority to packets that do not meet the aforesaid classifying conditions, and the packets having the lower priority set thereto are transferred to the classifying unit 121 from the marking unit 230.

When the first switch 240 is set to the position “inoperative”, the QoS function is rendered inoperative, and the marking unit 230 sets lower priority to the packets transferred from the first interface unit 110, whereby the packets having the lower priority set thereto are transferred to the classifying unit 121 from the marking unit 121.

The second interface unit 220 according to the present embodiment is similar in behavior to that according to the sixth embodiment, and therefore descriptions thereon are herein omitted.

As described above, when the first switch 240 is set to the position “partially operative”, the packet-relay unit 200 according to the present embodiment allows the second switch 250 to optionally set the classifying conditions for use in packet classification executed by the marking unit 230.

The conditions to be set by the second switch 250 may include header information such as, e.g., a DSCP, a TOC, a VLAN priority bit, a MAC address, an IP address, a port number, a protocol number, and a flow label.

### EIGHTH EMBODIMENT

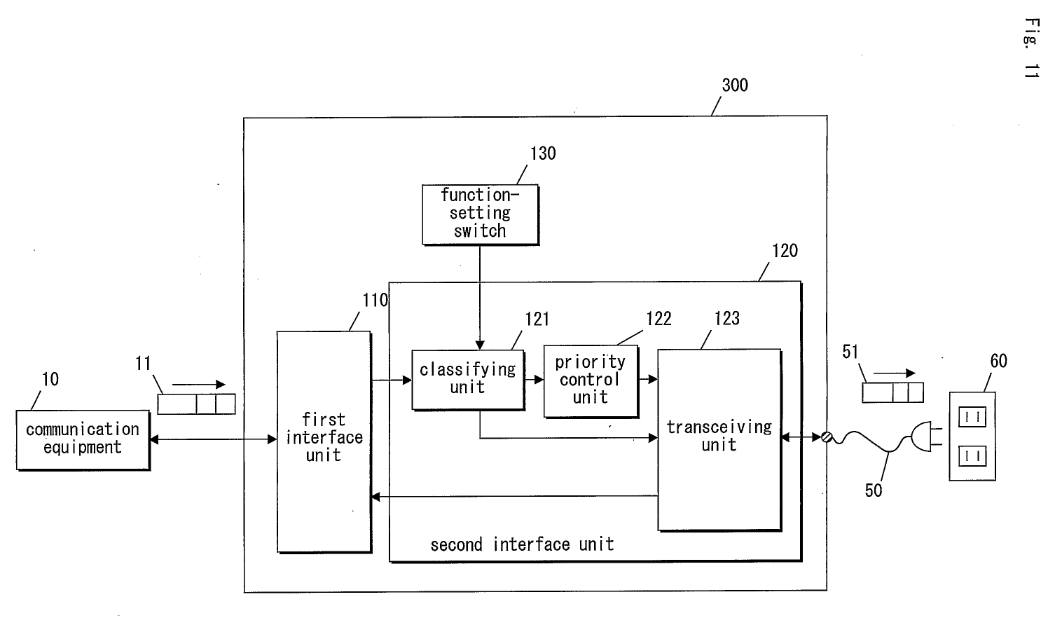

FIG. 10 is an illustration showing an exemplary packet-relay unit according to an eighth embodiment when applied to a wireless LAN.

In the exemplary application according to the present embodiment, packet-relay units “100a” and “100b” are similar to the packet-relay unit 100 of FIG. 1 according to the first embodiment, and therefore specific descriptions on structures and behaviors thereof are herein omitted.

As illustrated in FIG. 10, the exemplary application according to the present embodiment provides communication equipment “10a” connected to the packet-relay unit “100a” via a cable (e.g., Ethernet®) and connected to an access point (AP) 30 on a network 40 by radio through the packet-relay unit “100a”, and communication equipment “10b” connected to the packet-relay unit “100b” via a cable and connected to the access point (AP) 30 by radio through the packet-relay unit “100b”. The packet-relay units “100a”, “100b” include antennas “20a”, “20b” for use in wireless connection to the access point (AP) 30, respectively.

According the example of FIG. 10, a function-setting switch “130a” on the packet-relay unit “100a” for use in setting a QoS function is set as “QoS operative”, and the packet-relay unit “100a” performs priority control over packets transmitted from the communication equipment “10a”. Meanwhile, a function-setting switch “130b” on the packet-relay unit “100b” for use in setting a QoS function is set as “QoS inoperative”, and the packet-relay unit “100b” provides no priority control over packets transmitted from the communication equipment “10b”.

Assume that the communication equipment “10a”, “10b” transmit the packets concurrently under the setting conditions as discussed above. In this instance, the packets from the communication equipment “10a” are treated in preference to those from the communication equipment “10b”, and are first transmitted to the access point (AP) 30.

Thus, the packet-relay unit 100 according to the first embodiment may be applied to the packet-relay unit “100a”, “100b” according to the present invention, and the packet-relay units “100a”, “100b” according to the present invention provide the priority control over packets transmitted from the communication equipment 10, even when the packets are not priority-controlled by the communication equipment 10.

### NINTH EMBODIMENT

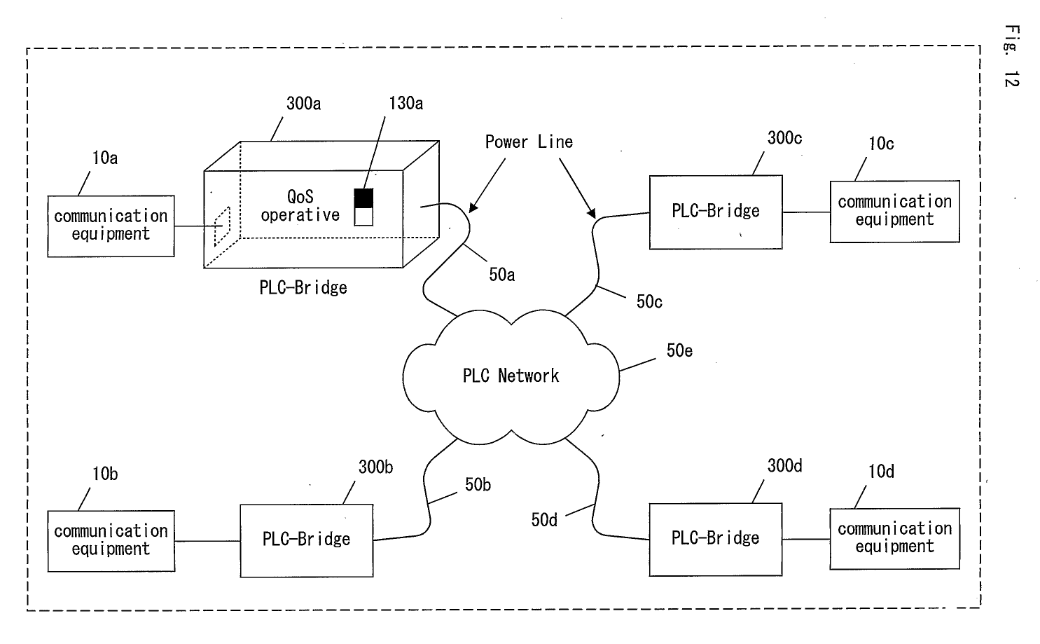

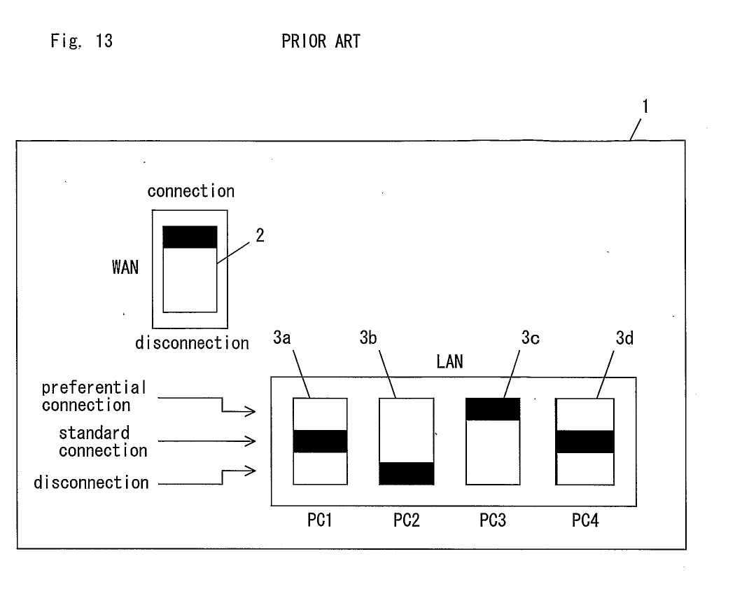

FIG. 11 is a block diagram illustrating a packet-relay unit 300 according to a ninth embodiment. The packet-relay unit 300 according to the present embodiment is similar to the packet-relay unit 100 of FIG. 1 according to the first embodiment. In FIG. 11, elements similar to those of FIG. 1 are identified by the same reference characters, and descriptions thereon are herein omitted.

In the packet-relay unit 300 according to the present embodiment, a transmission medium connected to a second interface unit 120 is a balanced transmission channel for use in power line communication, and a transceiving unit 123 is connected to an in-home power line outlet 60 through a power line 50. The packet-relay unit 300 provides predetermined priority control over packets 11 transmitted from communication equipment 10, and the priority-controlled packets 11 are transmitted in the form of packets 51 to a power line network through the power line 50. The power line network is connected to the in-home power line outlet 60.

FIG. 12 is an illustration showing exemplary packet-relay units according to the present embodiment when applied to a power line network. According to the illustrated example of FIG. 12, the packet-relay unit 300 of FIG. 11 is used as PLC-Bridges (Power Line Communication-Bridges) “300a”, “300b”, “300c”, and “300d”. The PLC-Bridges “300a” to “300d” are operable to relay communication equipment “10a” to “10d” to a power line network “50e” through power lines “50a” to “50d”, respectively. To set a QoS functions of each of the PLC-Bridges “300a” to “300d”, the PLC-Bridges “300a” to “300d” include function-setting switches “130a” to “130d”, respectively. In FIG. 12, the function-setting switches “130b” to “130d” are omitted.

In the network as constructed above, the PLC-Bridge “300a” having the function setting switch “130a” set as, e.g., “QoS operative” as illustrated in FIG. 12 provides priority control over packets fed into the PLC-Bridge “300a” from the communication equipment “10a”, and the priority-controlled packets are preferentially treated in the power line network “50e”.

Assuming that the communication equipment 10 connected to the packet-relay unit 300 at the input thereof is inoperable to impart the priority control to the packets, the packet-relay unit 300 is operable to impart the priority control to the packets transferred from the communication equipment 10 while relaying the aforesaid packets. In addition, the function-setting switch 130 mounted on the chassis of the packet-relay unit 300 on the surface thereof is available to permit the packet-relay unit 300 to impart the priority control to the packets, and accordingly the priority control is readily settable, even with users innocent of detailed knowledge on the priority control.

This is the end of the descriptions on the packet-relay units according to the present invention and on the embodiments of the packet-relay units applied to the network.

Pursuant to the above embodiments, the marking unit 230 sets the priority to the packets. Alternatively, the second interface unit 220 at any element therein may set the priority to the packets. Although the priority control unit 122 sets the back-off time, the transceiving unit 123 may alternatively sets the back-off time.

According to the above embodiments, packets received by the second interface unit 120 from the network are transmitted through the first interface unit 110 without allowing a quality guarantee to be set to the transmitted packets. Alternatively, the aforesaid packets from the network may be transmitted in the same manner as that in which the packets received by the first interface unit 110 from the communication equipment 10 are transmitted through the second interface unit 120. As a result, the bidirectional quality guarantee can be performed by the packet-relay unit 100.

Although the packet-relay unit 100 according to the present invention is operable to set the QoS function between “operative” and “inoperative” using the function-setting switch 130, an alternative packet-relay unit without the QoS function-setting switch may provide a quality guarantee in wireless LAN systems as well.

For example, a “QoS-attached, packet-relay unit” and “QoS-free, packet-relay unit” as discussed below may be provided, whereby a differentiated quality guarantee is provided in wireless LAN circumstances. The “QoS-attached, packet-relay unit” eliminates the function-setting switch 130 of FIG. 1, but includes a classifying unit 121 operable in a manner similar to that in which the function-setting switch 130 is always rendered “operative”, whereby a quality guarantee is always provided. The “QoS-free, packet-relay unit” eliminates the function-setting switch 130 of FIG. 1 as well, but includes a classifying unit 121 operable in a manner similar to that in which the function-setting switch 130 is always rendered “inoperative”, whereby no quality guarantee is always provided.

In the exemplary packet-relay units applied to the wireless LAN system of FIG. 10, the “QoS-attached, packet-relay unit” may be used as the packet-relay unit “100a” operable to impart the quality guarantee to the packets, while the “QoS-free, packet-relay unit” may be used as the packet-relay unit “100b” inoperable to impart the quality guarantee to the packets. As a result, packets outputted from the packet-relay unit “100a” are transferred to the access point (AP) 30 in preference to packets from the packet-relay unit “100b”, thereby providing guaranteed communication quality.

### INDUSTRIAL APPLICABILITY

The packet-relay units according to the present invention are applicable to fields where packets must be relayed by such as a router in a wireless LAN, and to the related fields.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A packet-relay unit comprising:
a first network interface unit connected to first communication equipment through a first transmission medium;
a second network interface unit connected to second communication equipment through a second transmission medium; and
a function-setting switch operable to set a quality guarantee to packets fed into said first network interface unit from the first communication equipment,
wherein said second network interface unit includes:
a classifying unit operable to classify the packets in accordance with settings of said function-setting switch;
a priority control unit operable to provide priority control over the packets such that the packets outputted from said second network interface unit are preferentially treated at a communication zone between said second network interface unit and the second communication equipment; and
a transceiving unit operable to perform packet transmitting and receiving through the second transmission medium,
wherein when said function-setting switch is set to render the quality guarantee operative, said classifying unit transfers the packets from said first network interface unit to said priority control unit, and said priority control unit provides the priority control over the packets transferred from said classifying unit, whereby the packets subjected to the priority control are transferred to said transceiving unit from said priority control unit, and
wherein when said function-setting switch is set to render the quality guarantee inoperative, said classifying unit transfers the packets from said first network interface unit to said transceiving unit.

2. A packet-relay unit as defined in claim 1, wherein the first transmission medium differs from the second transmission medium.

3. A packet-relay unit as defined in claim 1, wherein the first transmission medium is a hardwired medium, but the second transmission medium is a wireless medium.

4. A packet-relay unit as defined in claim 1, wherein the first transmission medium is a hardwired medium, but the second transmission medium is a balanced transmission channel for use in power line communication.

5. A packet-relay unit as defined in claim 1, wherein said function-setting switch performs three-staged settings of the quality guarantee to the packets from said first network interface unit,
wherein when said function-setting switch performs a first-staged setting of the quality guarantee, said classifying unit transfers the packets from said first network interface to said priority control unit, and said priority control unit provides the priority control over the packets transferred from said classifying unit, whereby the packets subjected to the priority control are transferred to said transceiving unit from said priority control unit,
wherein when said function-setting switch performs a second-staged setting of the quality guarantee, said classifying unit transfers, to said priority control unit, a packet that satisfies a predetermined classifying condition among the packets from said first network interface unit, but transfers remnants of the packets from said first network interface unit to said transceiving unit, and said priority control unit provides the priority control over the packet that is transferred from said classifying unit and that satisfies the predetermined classifying condition, whereby the packet subjected to the priority control is transferred to said transceiving unit from said priority control unit, and
wherein when said fictions-setting switch performs a third-staged setting of the quality guarantee, said classifying unit transfers the packets from said first network interface unit to said transceiving unit.

6. A packet-relay unit as defined in claim 1, further comprising:
a priority control-setting switch,
wherein said priority control unit provides a different type of priority control over the packets from said first network interface unit in accordance with each setting of said priority control-setting switch.

7. A packet-relay unit as defined in claim 6, wherein said priority control-setting switch is set to allow said priority control unit to perform at least one of back-off setting, encoding rate setting, communication mode selection, and acknowledgement signal selection, by way of the priority control to be provided by said priority control unit over the packets from said first network interface unit.

8. A packet-relay unit as defined in claim 1, wherein said function-setting switch is a physical switch disposed at a position where appearance of said function-setting switch is viewable.

9. A packet-relay unit as defined in claim 6, wherein said priority control-setting switch is a physical switch disposed at a position where appearance of said priority control-setting switch is viewable.

10. A packet-relay unit comprising:
a first network interface unit connected to first communication equipment through a first transmission medium;
a second network interface unit connected to second communication equipment through a second transmission medium;
a first switch operable to set a quality guarantee to packets fed into said first network interface unit from the first communication equipment; and
a marking unit operable to set priority to the packets from said first network interface unit in accordance with settings of said first switch, whereby the packets having the priority set thereto are transferred to said second network interface unit from said marking unit,
wherein when said first switch is set to render the quality guarantee operative, said marking unit sets increased priority to the packets from said first network interface unit,
wherein when said first switch is set to render the quality guarantee inoperative, said marking unit sets reduced priority to the packets from said first network interface unit.

11. A packet-relay unit as defined in claim 10, wherein said second network interface unit including:
a classifying unit operable to classify the packets in accordance with the priority set by said marking unit;
a priority control unit operable to provide priority control over the packets such that the packets outputted from said second network interface unit are preferentially treated at a communication zone between said second network interface unit and the second communication equipment; and
a transceiving unit operable to perform packet transmitting and receiving through the second transmission medium,
wherein when said first switch is set to render the quality guarantee operative, said marking unit sets increased priority to the packets from said first network interface unit, whereby the packets having the increased priority set thereto are transferred to said classifying unit from said marking unit,
wherein when said first switch is set to render the quality guarantee inoperative, said marking unit sets reduced priority to the packets from said first network interface unit, whereby the packets having the reduced priority set thereto are transferred to said classifying unit from said marking unit,
wherein said classifying unit transfers the packets having the increased priority set thereto to said priority control unit, but transfers remnants of the packets from said first network interface unit to said transceiving unit, and
wherein said priority control unit provides the priority control over the packets that are transferred from said classifying unit and that have the increased priority set to the packets, whereby the packets subjected to the priority control are transferred to said transceiving unit from said priority control unit.

12. A packet-relay unit as defined in claim 11, wherein said first switch performs three-stage settings of the quality guarantee to the packets from said first network interface unit,
wherein when said first switch performs a first-staged setting of the quality guarantee, said marking unit sets increased priority to the packets from the first network interface unit, whereby the packets having the increased priority set thereto are transferred to said classifying unit from said marking unit,
wherein when said first switch performs a second-staged setting of the quality guarantee, said marking unit sets increased priority to a packet that satisfies a predetermined classifying condition among the packets from said first network interface unit, whereby the packet having the increased priority set thereto is transferred to said classifying unit from said marking unit, but said marking unit sets reduced priority to remnants of the packets from said first network interface unit, whereby the remnants having the reduced priority set thereto are transferred to said classifying unit from said marking unit, and
wherein when said first switch performs a third-staged setting of the quality guarantee, said marking unit sets reduced priority to the packets from said first network interface unit, whereby the packets having the reduced priority set thereto are transferred to said classifying unit from said marking unit.

13. A packet-relay unit as defined in claim 12, further comprising:
a second switch operable to set the classifying condition for use in packet classification,
wherein when said first switch performs the second-staged setting of the quality guarantee, said marking unit classifies the packets from said first network interface unit in accordance with the classifying condition set by said second switch.

14. A packet-relay unit as defined in claim 13, wherein said second switch sets the classifying condition based on at least one of a DSCP, a TOS, a VLAN priority bit, a MAC address, an IP address, a port number, a protocol number, and a flow label.
